(19) United States
(12) Patent Application Publication
(10) Pub. No.: US 2024/0287326 A1
(43) Pub. Date: Aug. 29, 2024

(54) POLYMER MATRIX IMMBOLIZED CARBON NETWORK FOR ELECTRICAL DISCHARGE OF ELECTROCHEMICAL DEVICES

(71) Applicant: The Government of the United States of America, as represented by the Secretary of the Navy, Arlington, VA (US)

(72) Inventors: Gordon H. Waller, Vienna, VA (US); Corey T. Love, Alexandria, VA (US); Rachel E. Carter, Washington, DC (US)

(73) Assignee: The Government of the United States of America, as represented by the Secretary of the Navy, Arlington, VA (US)

(21) Appl. No.: 18/585,046

(22) Filed: Feb. 22, 2024

Related U.S. Application Data
(60) Provisional application No. 63/486,526, filed on Feb. 23, 2023.

(51) Int. Cl. C09D 5/24; C09D 7/40; C09D 7/45; C09D 7/61; C09D 7/65; C09D 129/04; H01M 10/44

(52) U.S. Cl. CPC C09D 5/24; C09D 7/45; C09D 7/61; C09D 7/65; C09D 7/70; C09D 129/04; H01M 10/448

(57) ABSTRACT

Disclosed herein is a method of discharging a battery by providing a composition having a solution of a crosslinked or crosslinkable polymer and a solvent and conductive carbon particles; and applying the composition to a battery in contact with an anode and a cathode to form an electrical connection from the anode to the cathode.

### REFERENCE TO RELATED APPLICATIONS

This application claims the benefit of U.S. Provisional Application No. 63/486,529, filed on Feb. 23, 2023. The provisional application and all other publications and patent documents referred to throughout this nonprovisional application are incorporated herein by reference.

### TECHNICAL FIELD

The present disclosure is generally related to carbon/polymer materials for battery discharge.

### DESCRIPTION OF THE RELATED ART

Electrochemical energy storage devices, commonly referred to as batteries, are a critical power sources for many applications. Portable electronics, power tools, and increasingly electric vehicles, are dependent on high-energy density batteries, specifically lithium-ion batteries. However, these devices are capable of energetic failures when improperly used or abused. Furthermore, safety incidents relating to manufacturing defects have led to the recall of several products ranging in size and severity from smartphones to electric cars. In many instances batteries are disposed of while still containing residual energy, and this residual energy complicates the safe storage, transportation, and disposal or recycling. For lithium-ion batteries in particular the recovery of certain critical minerals including lithium, nickel, and cobalt is hampered by the cost associated with transporting end of life batteries, which in the United States must be labeled as Class 9 Hazardous Waste.

Limiting the state-of-charge (i.e. the fraction of the nominal energy content remaining in the device) below some threshold prior to shipping, usually <30%, is recommended to mitigate the hazards associated with residual energy in electrochemical devices. For newly manufactured devices, limiting the state-of-charge is the responsibility of the device manufacturer. However, for battery powered devices in the public, even confirming the current state-of-chart of the battery can be difficult if the battery is removed from the device, which is generally the case for disposal. Blocking access to terminals with an insulating barrier such as electrical tape or a polymer bag are also considered best practices prior to disposal, however this method is imperfect as it does not remove residual energy. Discharging cells through an appropriate load is another option to remove residual energy, however for smaller devices such as personal electronics or power tools, the voltage cutoff is limited to protect the functionality of the electrochemical energy storage device to some value >0 V per cell. For larger devices containing many cells in series, the cutoff voltage can be sufficient to result in hazardous conditions when subjected to a short circuit. Selecting an appropriate electrical load for discharge for electrochemical devices is not trivial, as even a small fraction of the original energy content can generate dangerous currents and heat. Previous efforts have focused on demonstrating a dynamic electrical load, which can be applied to a variety of electrochemical devices for safe discharge, however these devices limit throughput due to cost and complexity. Furthermore, manual interaction with battery terminals represents a potential safety risk to personnel. In an industrial setting, batteries are often shredded after immersing in water or even cryogenic fluids to mitigate the hazards of abusing high-energy density batteries. While shredding of batteries containing residual energy provides a high-throughput solution, transportation and storage of end-of-life batteries remains a concern, and safety events (i.e., large fires) have still been reported in these facilities.

### SUMMARY OF THE INVENTION

Disclosed herein is a method comprising: providing a composition comprising: a solution of a crosslinked or crosslinkable polymer and a solvent and conductive carbon particles; and applying the composition to a battery in contact with an anode and a cathode to form an electrical connection from the anode to the cathode.

Also disclosed herein is a composition comprising: 5-20 wt % of a polyvinyl alcohol; 1-50 wt % of conductive carbon particles; 5-10 wt % of a polyvinyl alcohol cross-linker; a surfactant; and water. The polyvinyl alcohol has a molecular weight of 9000-200,000 g/mol.

Also disclosed herein is a composition comprising: 5-20 wt % of a crosslinked polyvinyl alcohol; 1-50 wt % of conductive carbon particles; a surfactant; and water.

Also disclosed herein is a method comprising: providing a powdered composition comprising: a crosslinked or crosslinkable polymer; and conductive carbon particles; applying the composition to a battery in contact with an anode and a cathode to form an electrical connection from the anode to the cathode; and applying a solvent to the composition.

### BRIEF DESCRIPTION OF DRAWINGS

A more complete appreciation will be readily obtained by reference to the following Description of the Example Embodiments and the accompanying drawings.

FIG. 1 shows photographs of a polymer-carbon gel formed into a cube and allowed to flow over several minutes in a glass dish.

FIG. 2 shows photographs of a carbon-polymer gel extruded from a syringe onto a coin cell.

FIG. 3 shows a graph of the discharge of a lithium metal coin cell by polymer-carbon gel.

FIG. 4 shows a graph of the discharge of a lithium-ion 18650 cell by polymer-carbon gel.

FIG. 5 shows a graph of the discharge of a lantern battery cell by polymer-carbon gel.

FIG. 6 shows a graph of the discharge of an LIB cell by polymer-carbon gel.

FIG. 7 shows the chemical structure of an example gel made from polyvinyl alcohol (PVA) and sodium tetraborate decahydrate.

### DETAILED DESCRIPTION

In the following description, for purposes of explanation and not limitation, specific details are set forth in order to provide a thorough understanding of the present disclosure. However, it will be apparent to one skilled in the art that the present subject matter may be practiced in other embodiments that depart from these specific details. In other instances, detailed descriptions of well-known methods and devices are omitted so as to not obscure the present disclosure with unnecessary detail.

Disclosed herein is a method to de-energize batteries via electrical discharge which does not involve any electronic circuitry, is form factor and chemistry agnostic, is low cost and broadly dispersible, and offers protections against excessive heat build-up during discharge. This technology allows for end-of-life batteries to be safely de-energized wherever they are generated. De-energized batteries can then be safety aggregated for storage or transport to whatever end destination is required.

The method involves production and application of a water-soluble polymer and carbon composite gel, which is extruded or otherwise applied onto the electrical terminals of electrochemical cells and/or batteries. After application, the gel is allowed to dry, immobilizing the carbon content in a polymer matrix. The carbon quantity and morphology results in an electrically conductive network, and this electrical pathway between the terminals allows residual energy in the battery to be dissipated prior to storage, disposal, or recycling.

There are three main components:
1) Fabrication of a gel precursor solution containing an appropriate solvent (e.g. water), a polymer soluble in the solvent (e.g. polyvinyl alcohol), and one or more conductive carbon powders (e.g. graphite, carbon black, carbon filaments, or carbon nanotubes).
2) Gelation of the gel precursor using an appropriate method to initiate cross-linking of the dissolved polymer. Cross-linking can be achieved by a chemical additive (e.g. sodium tetraborate decahydrate solution in water) or by physical means (e.g. freezing and thawing, evaporation of the solvent).
3) Application of the carbon-polymer gel to the terminals of battery electrodes and allowing the solvent to evaporate. Once dry, a conductive carbon-polymer matrix is created which allows current flow between the battery terminals to dissipate residual energy from the device.

As an example of fabrication of the gel precursor, a desired content of polymer is added to a solvent and dissolved. As an example, 5-20 wt % of polyvinyl alcohol with a molecular weight of 9000 to 20,000 g/mol is dissolved into water by stirring at a temperature of 50-90° C. Once dissolved, the polymer solution is stable at room temperature. Next, a desired content of conductive carbon powder is dispersed into the polymer solution. As an example, 1-50% conductive carbon powder is added to the polymer solution while stirring or otherwise mixing the solution. The conductive carbon powder may be of a single type or of multiple types in a desired ratio. An appropriate surfactant may be introduced to aid in the dispersion of the conductive carbon powder. As an example, sodium dodecyl sulfate or Polysorbate-20 at concentrations above the critical micelle concentration are ionic and non-ionic surfactants, respectively utilized for the dispersion of conductive carbon powders in water. The gel-precursor can be stored indefinitely, however the conductive carbon powder may settle without occasional stirring or mixing.

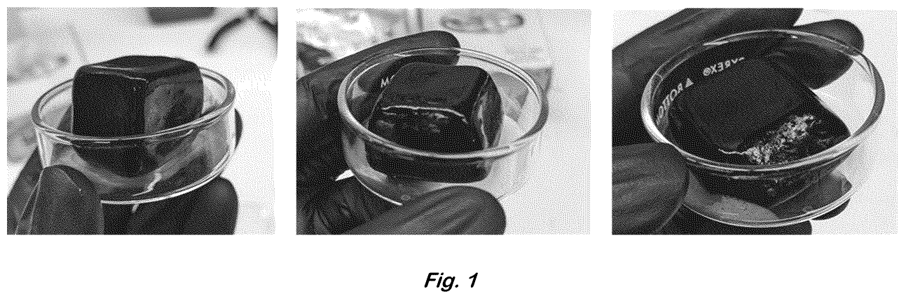

As an example of gelation of the gel precursor, a desired quantity of cross-linking agent is added to the gel precursor while stirring. As an example, 5-10 wt % sodium tetraborate decahydrate of the polymer content in the gel precursor is added during stirring or mixing until a homogenous gel is formed. The prepared gel is shelf stable as long as evaporation of the solvent is avoided. No mixing or re-dispersion of the conductive carbon additive is required. An example of a gel prepared in this way is shown in FIG. 1. In this case, a gel-precursor containing 10 wt % polyvinyl alcohol with a molecular weight of 31,000-50,000 g/mol, 10 mM sodium dodecyl sulfate, and 5 wt % multi-walled carbon nanotubes (MWCNT) was gelled by adding 5.2 wt % sodium tetraborate decahydrate based on the mass of polyvinyl alcohol. The as formed gel is viscous and compliant and can be formed into shapes, which slowly flow into a container as shown in FIG. 1. Once formed, the carbon-polymer gel is shelf stable provided evaporation of the solvent is avoided. FIG. 7 shows the chemical structure of gel made from PVA and sodium tetraborate decahydrate.

As an example of application of the carbon-polymer gel, the gel is directly applied to battery terminals by extruding from a syringe or similar application device as shown in FIG. 2. As the carbon-polymer gel dries, a conductive network is established which allows for electrical current flow between the battery terminals.

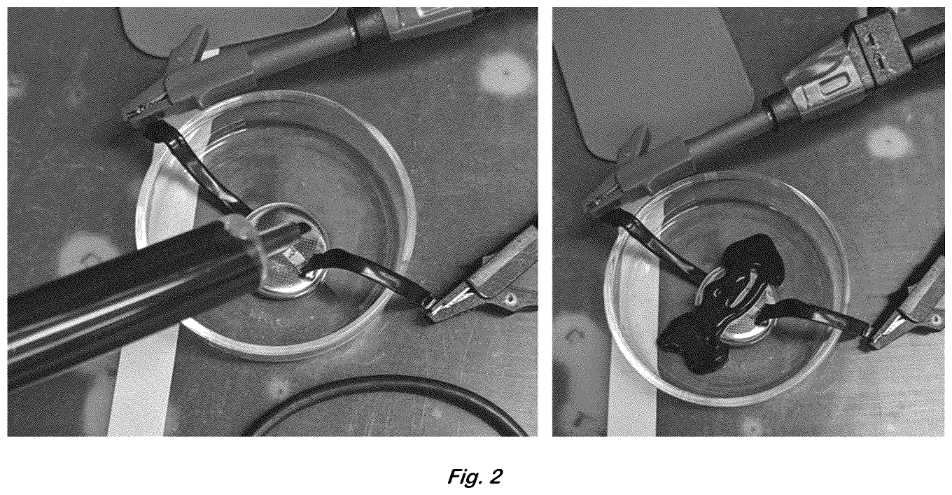

FIG. 3 shows a graph of the voltage response of a coin cell (shown in FIG. 2) to the application of a carbon-polymer gel. FIG. 4 shows the same for a larger 18650 cylindrical cell. FIG. 5 shows the same for an even larger 20 Ah lantern battery. FIG. 6 shows the same for a 1.8 Ah LIB pouch cell. Although the three cells have different chemistries, different geometries, different voltages, and differ in capacity by orders of magnitude, all cells were reduced to near 0 V, indicating complete dissipation of residual energy in the cells.

The rate at which cells can be discharged by the carbon-polymer gel may depend on several factors, including the geometry of the cell terminals (e.g. surface area and separation between terminals), the voltage of the cell, the capacity of the cell, and the composition of the carbon-polymer gel. Only the composition of the carbon-polymer gel is controllable, and a single composition may work for any type of cell or battery. Conductivity of the carbon-polymer gels increases as the solvent evaporates. The conductivity for several compositions of carbon-polymer gels which have been dried into 5 mm wide strips is provided in Table 1, which shows that the conductivity can be increased by several orders of magnitude by increasing the ratio of conductive carbon to PVA for a given type of conductive carbon powder (e.g. multi-walled carbon nanotubes, MWCNT) as well as using appropriate mixtures of carbon (e.g. carbon black and graphite).

TABLE 1
Conductivity of dried carbon-polymer gels

| Composition | Dry strip resistance |
|---|---|
| 1:10 MWCNT:PVA | 1.60E−03 S/m |
| 1:5 MWCNT:PVA | 9.81E−02 S/m |
| 1:2 MWCNT:PVA | 1.60E+01 S/m |
| 1:1 Graphite:PVA | 3.97E−04 S/m |
| 2:1 Graphite:PVA | 6.50E−01 S/m |
| 3:1 Graphite:PVA | 1.24E+00 S/m |
| 1:1 Carbon Black:PVA | 2.31E+01 S/m |
| 1:20:10 MWCNT:Graphite:PVA | 7.71E−01 S/m |
| 1:2:2 Carbon Black:Graphite:PVA | 3.71E+01 S/m |

In Table 2, the present method is compared to existing approaches to de-activate batteries.

TABLE 2
Comparison of desirable properties for battery deactivation

| | Polymer matrix | Discharge | | |
|---|---|---|---|---|
| | immobilized | through an | Insulating barrier | Mechanical |
| Feature | carbon | electrical load | on battery terminals | shredding |
| Complete removal of | Yes | Yes | No | Yes^{†} |
| residual energy | | | | |
| High throughput | Yes | No* | Yes | Yes |
| Low cost | Yes | No | Yes | Yes |
| Deployable | Yes | No | Yes | No |
| Form-factor agnostic | Yes | No | Yes | No |
| Chemistry agnostic | Yes | Yes | Yes | No |

*Assumes discrete number of load banks available for battery deactivation
^{†}Dissipating of residual energy during shredding occurs rapidly and is potentially hazardous

Several alternative methods of producing and applying the gel are possible, including:
Application of a gel or gel-precursor as an aerosol rather than via extrusion to enable control over the thickness of the conductive polymer-carbon matrix
Cross-linking of a gel-precursor using a physical (e.g. temperature, light) or other ambient method (e.g. exposure to oxygen, evaporation of solvent) to create a gel in situ on a desired surface
Application of the gel precursor as a dry powder to which water is added
Replacement of water with a suitable solvent, such as an alcohol or isopropyl alcohol, to improve wettability, viscosity, or drying rate of the gel for rapid formation of a conductive polymer-carbon matrix. A mixture of solvents may be used, such as a mixture of up to 50 vol. % alcohol in water.
Integration of a gel into a battery casing with a method to initiate drying of the solvent such that a conductive polymer-carbon matrix is formed to dissipate residual energy prior to battery disposal

Many modifications and variations are possible in light of the above teachings. It is therefore to be understood that the claimed subject matter may be practiced otherwise than as specifically described. Any reference to claim elements in the singular, e.g., using the articles “a”, “an”, “the”, or “said” is not construed as limiting the element to the singular.

1. A method comprising:
providing a composition comprising:
a solution of a crosslinked or crosslinkable polymer and a solvent; and
conductive carbon particles; and
applying the composition to a battery in contact with an anode and a cathode to form an electrical connection from the anode to the cathode.

2. The method of claim 1, further comprising:
allowing a portion of the solvent to evaporate to increase the conductivity of the composition.

3. The method of claim 1, further comprising:
allowing the battery to discharge while a current flows through the composition.

4. The method of claim 1, wherein the polymer is a polyvinyl alcohol.

5. The method of claim 1, wherein the solvent is water.

6. The method of claim 1, wherein the solvent is a mixture of up to 50 vol. % isopropyl alcohol in water.

7. The method of claim 1, wherein the carbon particles comprise multi-walled carbon nanotubes, carbon black, graphite, or a combination.

8. The method of claim 1, wherein the carbon particles comprise multi-walled carbon nanotubes.

9. The method of claim 1, wherein the composition further comprises:
a surfactant.

10. The method of claim 9, wherein the surfactant is sodium dodecyl sulfate or polyoxyethylene (20) sorbitan monolaurate.

11. The method of claim 1, wherein the composition further comprises:
a polymerization initiator.

12. The method of claim 11, wherein the polymerization initiator is sodium tetraborate decahydrate.

13. The method of claim 1, wherein applying the composition comprises extruding the composition.

14. The method of claim 1, wherein applying the composition comprises spraying an aerosol of the composition.

15. The method of claim 1, wherein the composition is incorporated into a casing containing the battery.

16. A composition comprising:
5-20 wt % of a polyvinyl alcohol;
wherein the polyvinyl alcohol has a molecular weight of 9000-200,000 g/mol;
1-50 wt % of conductive carbon particles;
5-10 wt % of a polyvinyl alcohol cross-linker;
a surfactant; and
water.

17. The composition of claim 16, wherein the polyvinyl alcohol has a molecular weight of 31,000-50,000 g/mol.

18. The composition of claim 16, wherein the carbon particles comprise multi-walled carbon nanotubes, carbon black, graphite, or a combination thereof.

19. The composition of claim 16, wherein the carbon particles comprise multi-walled carbon nanotubes.

20. The composition of claim 16, wherein the polyvinyl alcohol cross-linker is sodium tetraborate decahydrate.

21. The composition of claim 16, wherein the surfactant is sodium dodecyl sulfate or polyoxyethylene (20) sorbitan monolaurate.

22. A composition comprising:
5-20 wt % of a crosslinked polyvinyl alcohol;
1-50 wt % of conductive carbon particles;
a surfactant; and
water.

23. The composition of claim 22, wherein the carbon particles comprise multi-walled carbon nanotubes, carbon black, graphite, or a combination thereof.

24. The composition of claim 22, wherein the carbon particles comprise multi-walled carbon nanotubes.

25. The composition of claim 22, wherein the surfactant is sodium dodecyl sulfate or polyoxyethylene (20) sorbitan monolaurate.

26. A method comprising:
providing a powdered composition comprising:
a crosslinked or crosslinkable polymer; and
conductive carbon particles;
applying the composition to a battery in contact with an anode and a cathode to form an electrical connection from the anode to the cathode; and
applying a solvent to the composition.
